(19) United States
(12) Patent Application Publication
(10) Pub. No.: US 2025/0338165 A1
(43) Pub. Date: Oct. 30, 2025

(54) CONFIGURATION OF TIME SENSITIVE NETWORKING

(71) Applicant: Nokia Solutions and Networks Oy, Espoo (FI)

(72) Inventors: Christian MARKWART, Munich (DE); Rüdiger HALFMANN, Munich (DE); Hua CHAO, Shanghai (CN); Rakash SIVASIVA GANESAN, Munich (DE)

(21) Appl. No.: 18/871,583

(22) PCT Filed: Jun. 7, 2022
(86) PCT No.: PCT/CN2022/097473

§ 371 Date: Dec. 4, 2024

(51) Int. Cl. H04W 28/02; H04L 47/28; H04L 69/22

(52) U.S. Cl. CPC H04W 28/0268; H04L 47/28; H04L 69/22

(57) ABSTRACT

Embodiments of the present disclosure relate to methods, devices, apparatuses, and computer readable medium for macro-diversity transmission in a subnetwork. The method comprises: in response to receiving a first header identification associated with a Time Sensitive Communication (TSC) stream, a first device transmits, to a configuration entity of a transport network, a first stream requirement comprising two or more second identifications. Each of the two or more second identifications is associated with a corresponding second device configured for an interface end station in a first protocol plane. The first device receives communication configuration information indicating second header information from the configuration entity. Then, the first device transmits, to a second device operating as a source interface end station, the first header identification and third header information at least indicating the second header information. The second device is associated with a second identification of the two or more second identifications.

### FIELD

Embodiments of the present disclosure generally relate to the field of telecommunication and in particular, to devices, methods, apparatus, computer readable storage media and system for a configuration of Time Sensitive networking (TSN).

### BACKGROUND

With development of technology, the application scenarios of communication are becoming more diverse and customized. For example, the timing requirement may be specific to a traffic type, and the timing requirements are diverse with different traffic types accordingly. In some example situations, such as emergency communication, in-vehicle subnetwork, in-production subnetwork and so on, higher requirement of latency and reliability should be achieved. In turn, communication traffic type capable of providing the required low latency and reliability has been also introduced, for example, Ultra Reliable and Low Latency Communication (URLLC) traffic. However, the configuration of data network (which may be also referred to as the TSN in this disclosure) for transporting these time sensitive traffics (which may be also referred to as Time Sensitive Communication, TSC, stream) may be further optimized. In addition, identifying uniquely a data packet or data frame belonging a specific TSC stream in a plurality of traffic streams is also a key aspect.

### SUMMARY

In general, example embodiments of the present disclosure provide a solution for the configuration of TSN.

In a first aspect, there is provided a first device. The first device comprises: at least one processor; and at least one memory including computer program codes. The at least one memory and the computer program codes are configured to, with the at least one processor, cause the first device to: in response to receiving a first header identification associated with a Time Sensitive Communication (TSC) stream, transmit, to a configuration entity of a transport network, a first stream requirement comprising two or more second identifications, wherein each of the two or more second identifications is associated with a corresponding second device configured for an interface end station in a first protocol plane; receive, from the configuration entity, communication configuration information indicating second header information; and transmit, to a second device operating as a source interface end station, the first header identification and third header information at least indicating the second header information, the second device being associated with a second identification of the two or more second identifications.

In a second aspect, there is provided a second device. The second device comprises: at least one processor; and at least one memory including computer program codes. The at least one memory and the computer program codes are configured to, with the at least one processor, cause the second device to: receive, from a first device, a third header information and a first header identification associated with a Time Sensitive Communication (TSC) stream, wherein the second device is configured for an interface end station in a first protocol plane; and in response to detecting that a fifth header of a received data frame is matched with the first header identification, transmit, based on the third header information, the received data frame having a sixth header, the sixth header comprising the third header information.

In a third aspect, there is provided a second device. The second device comprises: at least one processor; and at least one memory including computer program codes. The at least one memory and the computer program codes are configured to, with the at least one processor, cause the second device to: receive from a first device, a fourth header information, wherein the second device is configured for an interface end station in a first protocol plane; and in response to detecting that at least one of local configuration and fourth header information is matched with a sixth header of a received data frame, remove the sixth header and process the frame.

In a fourth aspect, there is provided a third device. The third device comprises: at least one processor; and at least one memory including computer program codes. The at least one memory and the computer program codes are configured to, with the at least one processor, cause the third device to: derive, from a first configuration of a Time Sensitive Communication (TSC) stream, a first header identification associated with the TSC stream; and transmit the first header identification to a first device.

In a fifth aspect, there is provided a method implemented at a first device. The method comprises: in response to receiving a first header identification associated with a Time Sensitive Communication (TSC) stream, transmitting, to a configuration entity of a transport network, a first stream requirement comprising two or more second identifications, wherein each of the two or more second identifications is associated with a corresponding second device configured for an interface end station in a first protocol plane; receiving, from the configuration entity, communication configuration information indicating second header information; and transmitting, to a second device operating as a source interface end station, the first header identification and third header information at least indicating the second header information, the second device being associated with a second identification of the two or more second identifications.

In a sixth aspect, there is provided a method implemented at a second device. The method comprises: receiving, from a first device, a third header information and a first header identification associated with a Time Sensitive Communication (TSC) stream, wherein the second device is configured for an interface end station in a first protocol plane; and in response to detecting that a fifth header of a received data frame is matched with the first header identification, transmitting, based on the third header information, the received data frame having a sixth header, the sixth header comprising the third header information.

In a seventh aspect, there is provided a method implemented at a second device. The method comprises: receiving from a first device, a fourth header information, wherein the second device is configured for an interface end station in a first protocol plane; and in response to detecting that local configuration and/or fourth header information is matched with sixth header of a received data frame, removing the Ethernet header and process the frame.

In an eighth aspect, there is provided a method implemented at a third device. The method comprises: deriving, from a first configuration of a Time Sensitive Communication (TSC) stream, a first header identification associated with the TSC stream; and transmitting the first header identification to a first device.

In a ninth aspect, there is provided an apparatus. The apparatus comprises: means for in response to receiving a first header identification associated with a Time Sensitive Communication (TSC) stream, transmitting, to a configuration entity of a transport network, a first stream requirement comprising two or more second identifications, wherein each of the two or more second identifications is associated with a corresponding second device configured for an interface end station in a first protocol plane; means for receiving, from the configuration entity, communication configuration information indicating second header information; and means for transmitting, to a second device operating as a source interface end station, the first header identification and third header information at least indicating the second header information, the second device being associated with a second identification of the two or more second identifications.

In a tenth aspect, there is provided an apparatus. The apparatus comprises: means for receiving, from a first device, a third header information and a first header identification associated with a Time Sensitive Communication (TSC) stream, wherein the second device is configured for an interface end station in a first protocol plane; and means for in response to detecting that a fifth header of a received data frame is matched with the first header identification, transmitting, based on the third header information, the received data frame having a sixth header, the sixth header comprising the third header information.

In a eleventh aspect, there is provided an apparatus. The apparatus comprises: means for receiving from a first device, a fourth header information, wherein the second device is configured for an interface end station in a first protocol plane; and means for in response to detecting that local configuration or fourth header information is matched with sixth header of a received data frame, removing the Ethernet header and process the frame.

In a twelfth aspect, there is provided an apparatus. The apparatus comprises: means for deriving, from a first configuration of a Time Sensitive Communication (TSC) stream, a first header identification associated with the TSC stream; and means for transmitting the first header identification to a first device.

In a thirteenth aspect, there is provided a non-transitory computer readable medium. The non-transitory computer readable medium comprises program instructions for causing an apparatus to perform the method according to any of the fifth aspect to eighth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a signaling process illustrating the configuration of TSN according to some example embodiments of the present disclosure;

FIG. 3 illustrates a data frame having a TSN transport stream header according to some example embodiments of the present disclosure;

FIG. 4 illustrates a flowchart of an example method for the configuration of TSN implemented at a first device according to example embodiments of the present disclosure;

FIG. 5 illustrates a flowchart of an example method for the configuration of TSN implemented at a second device according to example embodiments of the present disclosure;

FIG. 6 illustrates a flowchart of an example method for the configuration of TSN implemented at another second device according to example embodiments of the present disclosure;

FIG. 7 illustrates a flowchart of an example method for the configuration of TSN implemented at a third device according to example embodiments of the present disclosure; and

FIG. 8 illustrates a simplified block diagram of an apparatus that is suitable for implementing example embodiments of the present disclosure; and

FIG. 9 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, Wireless Local Area Network (WLAN), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the configuration of TSN for transporting TSC stream may be further optimized.

In one solution, TSC was introduced as an essential part of URLLC. TSC utilizes TSN features in fully centralized model as specified in IEEE Std 802.1 standards. The 5G System (5GS) acts as a Layer 2 bridge in a TSN network and supports TSN streams as periodic deterministic time-sensitive Ethernet traffic flows. Specifically, a Centralized Network Configuration (CNC) collects TSN stream requirements from Centralized User Configuration (CUC), schedules TSN streams, and configures each transport network bridge, including the 5GS Bridge, along the determined path. For 5GS Bridge, TSN Application Function (TSN AF) receives TSN stream configurations from the CNC. Respective Per-Stream Filtering and Policing (PSFP) information is used to derive TSC Assistance Container (TSCAC), which contains flow direction, periodicity, and Burst Arrival Time (BAT).

In another solution, native TSC was introduced to provide deterministic transmission capability without relying on TSN specific functions. Since then, 5GS has defined generic enablers for native TSC and TSN. Exposure for TSC service can support both Ethernet and IP traffic. TSC AF can request a service with certain Quality of Service (QoS) requirement as well as specific time synchronization option. A new Network Function (NF) Time Sensitive Communication and Time Synchronization Function (TSCTSF) are introduced to take care of time synchronization, individual QoS parameters, and TSC Assistance Information (TSCAI) determination. TSCAI was extended with the optional survival time parameter.

In a yet solution, TSN Transport Network for N3 data exchange between Radio Access Network RAN node and User Plane Function (UPF) is used, in order to support a better end-to-end determinism and low latency communication.

In a further solution, for each TSC stream, a separate Quality of Service (QoS) flow is established, and for each QoS flow, an individual GTP tunnel is set up. This may lead to a dramatic increase of the number of GTP tunnels per PDU session. Further, for identifying a data packet belonging to a specific TSC stream, User Network Interface (UNI) may be extended to use Tunnel Endpoint Identifier (TEID) and QoS Flow Identifier (QFI) as addition information to identify the data packet. This may require additional modification on current architecture.

However, in the 5GS operating as a TSN bridge, there is no suitable solution for identifying uniquely a data packet or a data frame belonging to a specific TSC stream in multiple parallel TSC streams. Further, a Session Management Function (SMF) for a protocol data unit (PDU) session is also not aware of the information on which end station, ports and Medium Access Control (MAC) addresses are used to transfer PDU packets via the N3 interface in the Layer 2 plane and are available for transmitting TSC streams.

In order to solve the above and other potential problems, embodiments of the present disclosure provide an improved mechanism for the configuration of TSN, in order to achieve a deterministic configuration of a TSN transport network and identify uniquely a data frame or data packet belonging to a specific TSC stream. According to the mechanism for the configuration of TSN, a first device configured for at least one of SMF and a Centralized User Configuration (CUC) transmits a first stream requirement comprising two or more second identifications to a configuration entity of a transport network in response to receiving a first header identification associated with a TSC stream. Each of the two or more second identifications are associated with a corresponding second device configured for an interface end station in a first protocol plane. The first device receives communication configuration information indicating second header information from the configuration entity. Then, the first device transmits the first header identification and third header information at least indicating the second header information to a second device operating as a source interface end station. The second device is associated with a second identification of the two or more second identifications.

In this way, for the SMF, without increasing the number of GTP tunnels significantly, a deterministic user plane TSN transport network for a TSC stream is configured, and the data frame or data packet belonging to a specific TSC stream can be identified or recognized uniquely in the transport network.

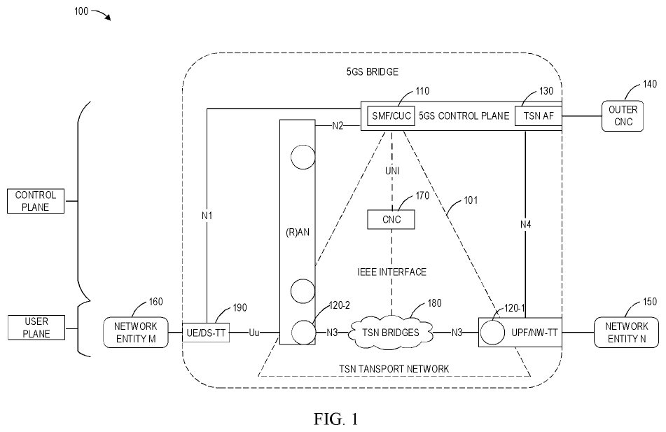

FIG. 1 illustrates an example network environment 100 in which embodiments of the present disclosure can be implemented. As shown in FIG. 1, the network environment 100, which may be a part of a communication network, comprises a user plane and a control plane. In the example as shown in network environment 100, a TSN network 101 which may be configured to transport a TSC stream comprises a Session Management Function (SMF) and/or a Centralized User Configuration (CUC) 110 (which may also referred to as a first device 110 in this disclosure). The TSN network 101 further comprises one or more User Plane Functions (UPF) 120-1 (which may be also referred to as a second device 120-1 in this disclosure) operating as an interface end station in a first protocol layer. The TSN network 101 further comprises (Radio) Access Network, (R)AN, as shown in FIG. 1. The (R)AN consists of at least one RAN node (as exemplarily illustrated by the circles in the RAN), one of the at least one RAN node may have one or more ports. A RAN node 120-2 having at least one port may be selected to operate as another interface end station in the first protocol layer, for example, a source interface end station or a sink interface end station in TSN transport network 101. Each of the UPF 120-1 and the RAN node 120-2 may operate as an N3 interface in Layer 2, and they may be collectively referred as second devices accordingly. For example, the UPF 120-1 may be referred as a second device 120-1, and the (R)AN node 120-2 may be referred as a second device 120-2. In addition, in this disclosure, without any limitation, the second device, N3 interface in Layer 2 and interface end station may be used interchangeably. In some embodiments, in uplink data transmission, a RAN node 120-2 may operate as a source interface end station in the TSN network 101. The RAN node 120-2 operating as the source interface end station transmits uplink data packet to a UPF 120-1 via at least one TSN bridge in the TSN transport network which is configured by a Central Network Controller (CNC) of the TSN transport network. Correspondingly, the UPF 120-1 operates as a sink interface end station in the TSN network 101 in the uplink data transmission.

In turn, in downlink data transmission, a RAN node 120-2 may operate as a sink interface end station in the TSN network 101. In this case, the RAN node 120-2 operating as the sink interface end station may receive downlink data packet from the UPF 120-1 via at least one TSN bridge in the TSN transport network which is configured by a Central Network Controller (CNC) of the TSN transport network. Correspondingly, the UPF 120-1 operates as a source interface end station in the TSN network 101 in the downlink data transmission.

In addition or alternatively, without any limitation, the source interface end station may be also referred to as a talker interface end station, and the sink interface end station may be also referred to as a listener interface end station. In some embodiments, the first protocol plane comprises the user plane. The interface end station as discussed above comprises a N3 interface in the Layer 2 plane. In this disclosure, the TSC stream is a stream transmitted over a TSN, the device 170 may operate as a Central Network Controller (CNC) in the TSN transport network.

As shown in FIG. 1, the SMF/CUC 110 and a TSN Application Function (AF) 130 form a part of the 5GS control plane for a 5GS bridge which is acting in an outer data network (not shown in FIG. 1). In addition or alternatively, the block indicated by the reference number 130 may be also a Time Sensitive Communication Time Synchronization Function (TSC TSF). In this disclosure, the TSN AF or TSC TSF 130 may be also referred to as a third device 130. In this architecture, a TSC stream is configured at the TSN AF 130 (or TSC TSF 130) by a CNC (or AF 140) outside the TSN transport network 101, for example, the outer CNC 140. According to example embodiments of this disclosure, the TSN AF 130 transmits TSC stream configuration information adapted to 5GS and a header identification associated with the TSC stream to the SMF/CUC 110 for configuring the data link for the TSC stream in the TSN transport network 101. For example, the outer CNC 140 configures, at the third device 130, a TSC stream which is required to transmit from the network entity 150 to the network entity 160. The third device 130 transmits TSC stream configuration information adapted to 5GS and a header identification derived based on the TSC stream configuration containing the destination address (for example, the address of the network entity 160) to the SMF/CUC 110 for configuring the data link in the TSN transport network 101. In this disclosure, the above destination address (the address of the network entity 160) outside the TSN transport network 101 may be also referred to as a second Destination MAC Address (DMAC). Then, the SMF/CUC 110 may request from a configuration entity (for example, CNC 170) of the TSN transport network 101 a merged end station communication configuration which is used for transporting the TSC stream in the TSN transport network 101. In an example, the SMF/CUC 110 transmits merged stream requirements based on the TSC stream configuration information adapted to 5GS and the header identification associated with the TSC stream to the CNC 170. In turn, the CNC 170 feedback the merged end station communication configuration for the source and sink interface end stations in the TSN transport network 101 to the SMF/CUC 110 in response to the request. The merged end station communication configuration at least indicates for the TSC stream the source interface end station address of the data link in the TSN transport network 101, the destination interface end station address, and the destination address of the TSC stream in the TSN transport network (which may be also referred to as a first DMAC in the TSN transport network 101 in this disclosure). Based on the merged end station communication configuration indicated by the SMF/CUC, the source interface end station derives and adds an unique TSN Transport stream header to the packets of a TSC stream. Then, the source and sink interface end stations use the unique TSN Transport stream header to exchange the packets of the TSC stream. As such, the second devices 120-1 or 120-2 operating as the source or sink interface end station may be enabled to uniquely identify a data frame/data packet belonging to the TSC stream and perform corresponding operations.

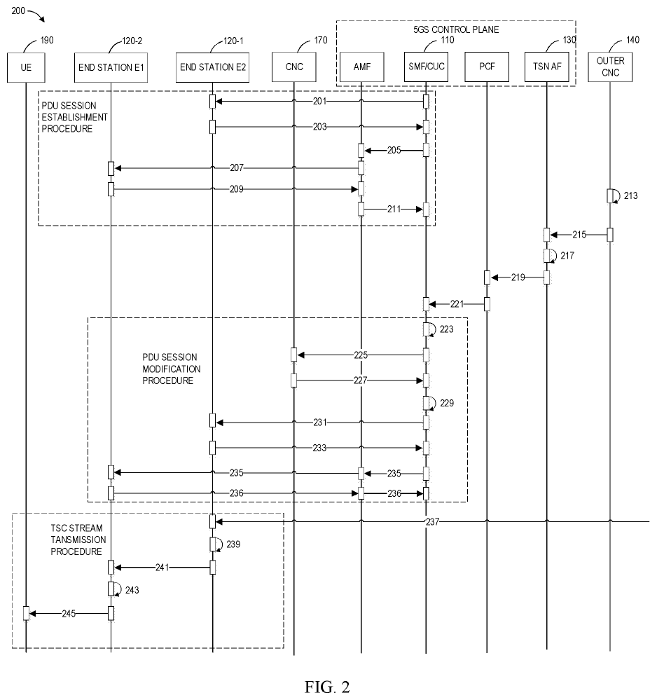

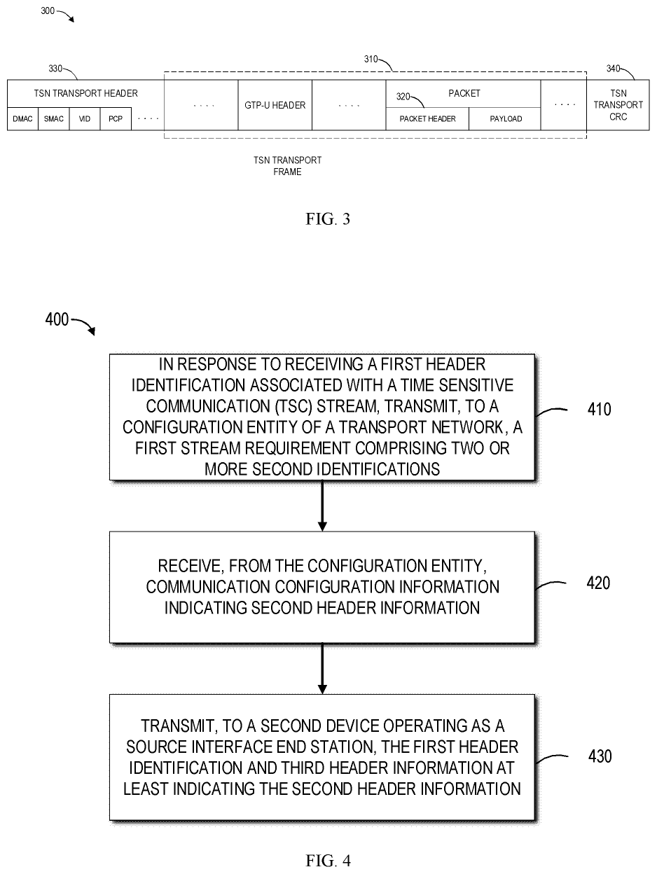

It is to be understood that the above steps are discussed only for the purpose of presenting the solution in general without any limitation. The detailed implementation of this disclosure is further discussed in detail with reference to FIGS. 2 and 3.

It is also to be understood that the number of the devices as shown in FIG. 1 are only for the purpose of illustration without suggesting any limitations. For example, the UPF 120-1 may include any suitable number of UPFs adapted for implementing embodiments of the present disclosure.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and/or any further communication protocols.

Principle and implementations of the present disclosure will be described in detail below with reference to FIGS. 2 and 3.

FIG. 2 illustrates a signaling process 200 illustrating the configuration of TSN according to some example embodiments of the present disclosure. For purpose of discussion, the signaling process 200 will be described with reference to FIG. 1.

In the signaling process 200, the PDU session establishment procedure, the PDU session modification procedure and the TSC stream transmission procedure are shown. In FIG. 2, without any limitation, some embodiments of this disclosure are discussed in the context of the downlink transmission. Based on the reciprocity of the data link, uplink configuration and uplink transmission for a TSC stream may be performed in a similar way.

In the PDU session establishment procedure, a plurality of second devices (for example, the second devices 120-1 and 120-2) available for transporting TSC stream report their identification and/or port identifications to the SMF/CUC 110. In this disclosure, the reported identifications may be also referred to as the second identifications associated with the second devices, for example 120-1 and 120-2. In some embodiments, the second identification comprises a MAC address in the TSN transport network 101. In this way, the Control Plane Network Function can be aware of the second devices or their ports available for the TSC streams in the User Plane directly.

In some embodiments, for the second device 120-1 corresponding to a UPF, the second identifications associated with the second devices are reported from UPF to the first device 110 in the N4 establishment/modification response of the PDU session establishment procedure. The report from UPF to the first device 110 may be initiated by a request from the first device via N4 signaling. In an example, a new traffic element for the establishment/modification response is added, and this traffic element allows to report the second identifications associated with the second devices from UPF to SMF. In addition, the N4 establishment/modification request may be initiated by a corresponding layer 2 information request. For example, at step 201, the first device 110 may transmit an N4 Session Establishment/Modification Request to the second device 120-1. In an example, the N4 Session Establishment/Modification Request further comprises a TSN N3 interface identification request. At step 203, in response to the N4 Session Establishment/Modification Request, the second device 120-1 transmits an N4 Session Establish/Modification response to the first device 110. The N4 Session Establish/Modification response further comprises at least one of: the second identification of the second device 120-1, the second identification of ports of the second device 120-1 on which TSC stream can be transferred.

For the second device 120-1 corresponding to a RAN node, the second identifications associated with the second devices are reported from RAN node to the first device 110 in the N2 message and Nsmf service message of the PDU session establishment procedure. The report from the RAN node to the first device 110 may be initiated by a request from the first device 110 via Namf service and N2 message. In addition, the Namf service from the SMF and N2 message from the AMF may be initiated by a corresponding layer 2 info request. For example, the second identifications are integrated into the N2 PDU Session Response and Nsmf_PDUSession_UpdateSMContext Request message of the PDU session establishment procedure. In an example, at step 205, the first device 110 transmits Namf_Communication_N1N2MessageTransfer message comprising a TSN N3 identification request to Access and Mobility Management Function (AMF). In response to the Namf service message, at step 207, the AMF transmits N2 PDU Session Request comprising the TSN N3 identification request to the second device 120-2. At step 209, the second device 120-2 feedback to the AMF with N2 PDU Session Response indicating at least one of: the second identification of the second device 120-1, the second identification of ports of the second device 120-1 on which TSC stream can be transferred. At step 211, the AMF transmits Nsmf_PDUSession_UpdateSMContext message indicating the second identifications associated with the second device 120-1 to the first device 110.

In addition or alternatively, if the second devices 120-1 and 120-2 each comprise a single port, the second devices may only report the second identifications of the second devices.

In this way, the Control Plane Network Functions of the TSN transport network 101 directly obtain the information on the second identifications associated with the N3 interface in Layer 2 which support TSN transport network.

In the PDU session modification procedure, in response to detecting that a TSC stream to be performed, Control Plane Network Function configure or adapt the communication configuration for the TSN transport network 101 to transfer the TSC stream.

At step 213, the outer CNC 140 detects a TSC stream to be transmitted. Then, the outer CNC 140 calculates or schedules a network path for the TSC stream. For example, the outer CNC 140 determines that the TSC stream should be transmitted along a network path from the network entity N 150 to the network entity M 160. Then, at step 215, the outer CNC 140 configures for the TSN stream the Static Filtering Entry (SFE) and Respective Per-Stream Filtering and Policing (PSFP) with the respective Null Stream Identification stream at the TSN AF 130 of the 5GS Bridge.

At step 217, for each TSC stream, the third device 130 which is configured for TSN AF 130 or TSC TSF 130 derives a TSC stream header identification for transporting the TSC stream in the TSN transport network 101, based on TSN stream configuration information provided by the Outer CNC 140. In this disclosure, the TSC stream header identification may be also referred to as a first header identification. In some embodiments, the first header identification is able to uniquely identify the TSC stream to be performed.

In some embodiments, the TSC stream configuration information provided by the outer CNC 140 comprises the Bridge configuration. In addition or alternatively, the TSC stream configuration information provided by an Application Function comprises the 5GS configuration for a native TSC stream.

In some embodiments, if the TSC stream is a TSN stream of Ethernet or IP type, then the first header identification may be built by using DMAC (which may be also referred to as the second DMAC) and VLAN Identifier of the TSC stream. IEEE 802.1 TSN IEEE 802.1 standards guarantee that this information is unique for each TSN stream transferred in a TSN domain via a 5GS bridge. In an example, the first DMAC may comprise the MAC address of the network entity M 160. In some other embodiments, the first DMAC may comprise other MAC addresses of other network entity.

In addition or alternatively, if the TSC stream is a native TSC stream of Ethernet or IP type, then the first header identification may be built by using the second DMAC and Virtual Local Area Network ID (VID) of the TSC stream. Further, the native TSC Streams may also require to use the Source MAC Address (SMAC) (which may be also referred to as a second SMAC) of the TSC stream to uniquely identify the Ethernet stream. In an example, the second SMAC may comprise the MAC address of the network entity N 150. In some other embodiments, the second SMAC may comprise other MAC addresses of other or same network entity.

In addition or alternatively, if the TSC stream is of IP type, then the first header identification may be built by using the IPv4, IPv6-tuples, containing SourceIpAddress, DestinationIpAddress, Dscp, Protocol, SourcePort, and DestinationPort of the TSC stream.

In addition or alternatively, the first header identification of the TSC stream may be built by using any part of a TSC stream packet: a DMAC (which may be also referred to as a second DMAC), a Source MAC Address (SMAC) (which may be also referred to as a second SMAC), a VID (which may be also referred to as a second VID), a Priority Code Pint (PCP) ((which may be also referred to as a second PCP), a EtherType value (which may be also referred to as second EtherType value), and a mac_service_data_unit (which may be also referred to as a second mac_service_data_unit);

After deriving the first header identification associated with a TSC stream, at step 219, the third device 130 transmits the first header identification to the first device 110.

In some embodiments, at steps 219 and 221, the third device 130 transmits the first header identification associated with the TSC stream to the first device 110 via Policy Control Function (PCF). In an example, the first header identification is carried within TSC Assistance Container (TSCAC). In another example, the first header identification is carried within Npcf_PolicyAuthorization_Update service.

At step 223, upon the first header identification associated with the TSC stream is received, the first device 110 which also acts on behalf of a N3 interface end station may derive or build a corresponding TSN Transport Stream Requirement which may be transmitted to CNC 170 for obtaining a respective communication configuration of the TSN transport network 101. In this disclosure, this TSN Transport Stream Requirement may be also referred to as a first stream requirement.

In some embodiments, the first device 110 derives the source interface end station and the sink interface end station in the TSN transport network 101 based on the 3GPP information. In an example, the first device 110 may identify a PDU session that transfers the TSC stream and uses the PDU session information (for example, Tunnel Endpoint Identifier TEID of GPRS tunneling Protocol GTP tunnel) to derive the interface end stations pair and the flow direction information of the TSC stream, and further the source interface end station and sink interface end station identifications within the TSN transport network 101. If multiple source interface end station identifications and multiple sink interface end station identifications are provided within the TSN transport network 101, the first device 110 may select at least a single interface source interface end station identification, at least a single sink interface end station identification (which both may also be referred to as second identification(s)), and incorporate the second identifications associated with the derived source and sink end stations into the first stream requirement (which may be also referred to as a merged stream requirements for the TSN Transport Stream).

In some embodiments, as discussed above, the first device 110 may use the PDU session information to derive the pair of the source interface end station and the sink interface end station. Then, based on the second identifications provided by the second devices at steps 203 and 211, the first device 110 may derive at least two second identifications, and each of the at least two second identifications is associated with one of the derived source interface end station and the sink interface end station. In an example, if each of these two interface end stations only supports a single port, then the first device 110 may derive only two second identifications in which each of the two second identifications correspond to one of the source and sink pair one by one. In another example, if the source interface end station or the sink interface end station has multiple ports available for TSN transport network 101, the first device 110 may incorporate at least one of the associated second identifications into the first stream requirement (or the merged stream requirements for the TSN Transport Stream).

In a yet example, a first plurality of interface end stations in UPF may be selected to operate as source or sink interface end stations for an outer TSC stream. Correspondingly, a second plurality of interface end stations in (R)AN may be also selected to operate as sink or source interface end stations for an outer TSC stream. In some embodiments, an interface end station of the first plurality of interface end stations may have only a single port and another interface end station of the first plurality of interface end stations may have multiple ports. Moreover, the second plurality of interface end stations may have a similar configuration. In this case, the first device 110 may incorporate into the first stream requirement at least one second identification of each interface end station in the first and second plurality of interface end stations. For example, for a certain interface end station having multiple ports, the first device 110 may incorporate the station identification of the interface end station and at least one port identification of the interface end station into the first stream requirement. In another example, for another certain interface end station having a single port, the first device 110 may only incorporate the station identification of this certain interface end station into the first stream requirement.

It is to be understood that regardless of the number of selected interface end stations for transporting the outer TSC stream and the number of ports of an interface end station, any method for incorporating into the first stream requirement the second identifications associated with these selected interface end stations can be envisaged based on the embodiments as discussed above.

For discussion clarity, the following embodiments are discussed based on only one interface end station having a single port being selected to be the source interface end station and only one interface end station having a single port being selected to be the sink interface end station.

As the example shown in FIG. 2, the flow direction of the TSC stream is downlink direction, the derived source interface end station is the second device 120-1, and the derived sink interface end station is the second device 120-2. In this example, the first device 110 incorporates at least one of the second identifications provided by the second devices 120-1 and 120-2 into the first stream requirement. In some embodiments, the first device 110 incorporates at least one of the MAC addresses provided by the second devices 120-1 and 120-2 into the first stream requirement. It is to be understood that the second devices 120-1 and 120-2 are only example in FIG. 2. In some other embodiments, another second device configured for RAN may be selected to be the sink interface end station, and/or another second device configured for UPF may be selected to be the source interface end station.

In addition or alternatively, the second identifications of the second devices available for TSN transport network 101 are preconfigured at the first device 110. As such, the first device 110 may derive the second identifications for the TSC stream directly without receiving the second identifications from the second devices. In some other embodiments, the first device 110 may obtain the second identifications (for example, MAC addresses) of the TSN available second devices in any other ways.

Further, the first device 110 may generate a unique stream Identifier (ID) for the TSN stream transferring the TSC stream in the TSN transport network 101 and also incorporates the unique stream ID into the first stream requirement to identify the TSC stream.

In some embodiments, the unique stream ID for the TSC stream in the TSN network 101 may be generated by the first device 110 based on at least the second identification associated with the second device 120-1 operating as the source interface end station. In addition, the first device 110 may select a free Unique ID for the TSC stream. Then, the first device 110 generates the unique stream ID based on both the second identification associated with the second device 120-1 and the selected free Unique ID.

After determining the associated second identifications and the unique stream ID, the first device 110 may store the first header identification, the associated second identifications and the unique stream ID. Then, at step 225, the first device 110 transmits the first stream requirement (or the merged stream requirements for the TSN Transport Stream) comprising the associated second identifications for source and sink interface end stations, the unique stream ID and the first header identification to the CNC 170.

According to the first stream requirement, CNC 170 determines the network path, schedules resources for the TSC stream in the TSN transport network 101 and feedbacks the merged end station communication configuration to the first device 110 as a response. In the following, the merged end station communication configuration may be simply referred to as the communication configuration. At step 227, the first device 110 receives communication configuration information from the CNC 170, and the communication configuration information indicates additional header information for the TSC stream transporting in the TSN transport 101. In this disclosure, this additional header information may be also referred to as second header information.

In some embodiments, the second header information may indicate a destination address of the TSN stream transferring the TSC stream in the TSN transport network 101. In some embodiments, the destination address of the TSN stream may comprise a Multicast Address. In another, the address of the TSN stream may only comprise the second identification of the second device 120-2. In this disclosure, the above destination MAC Address of the TSN stream in the TSN transport network 101 is also referred to as the first DMAC in the TSN network 101 as mentioned above.

In addition or alternatively, the second header information may further indicate at least one of a Virtual Local Area Network ID (VID) in the TSN network 101 (which may be also referred to as a first VID in the TSN network 101), and a Priority Code Point (PCP) in the TSN network 101 (which may be also referred to as a second PCP in the TSN transport network).

In some embodiments, the first device 110 transmits the first stream requirement or receives the communication configuration information to or from CNC 170 via User Network Interface (UNI).

At step 229, upon receiving the communication configuration information, the first device 110 may update the stored first header identification, second identifications, and the unique stream ID by adding the second header information (which may be also referred to as first DMAC, first SMAC, first VID, first PCP, and first mac_service_data_unit) and modifying the second identifications as indicated in the communication configuration information. For example, if CNC 170 selects the second identification of the sink interface end station, the first device 110 may update the second identification associated with the sink interface end station accordingly. In another example, as discussed above, the first device 110 may incorporate multiple identifications (port identification) into the first stream requirement. In this case, CNC 170 may select one second identification of the second device for transporting the TSC stream and indicate the one second identification in the communication configuration information. Further, the first device 110 may use the second header information to build individual third header information and individual fourth header information. The third header information is provided to the source interface end station and the fourth header information is provided to the sink interface end station.

In some embodiments, the CNC 170 in TSN Transport network 101 may not include the VID parameter in the merged end station communication-configuration because the TSN Transport stream fits to the existing VLAN configuration. In this case, Control Plane Network Function (for example, SMF/CUC 110) that acts on behalf of the N3 interface end points is already aware of the VLAN configurations of the second devices 120-1 and 120-2 via local configuration. Through adding the local configured VID to the DMAC and PCP received from the CNC 170, the SMF/CUC 110 uses the local configuration (the existing VLAN configuration) together with the received second header information to generate the third header information which may be transmitted to the second device 120-1 for adding the TSN Transport Stream Header to the outer TSC stream. In addition or alternatively, the first device 110 may transmits the third information without the VID, and the second device 120-1 may add the sixth header (which is discussed in detail below) with the VID to the outer TSC stream based on local configuration of VLAN.

In addition or alternatively, there may be the TSN Transport network deployments where for example only the default Stream Reservation (SR) class A for TSN streams exist and only one PCP value is mapped to the SR class. This mapping is typically done by an OAM system (for example, Network Management System) managing the TSN Transport Network. In such deployments the CNC 170 may decide not to provide a PCP value. Then the SMF/CUC 110 or even the second device 120-1 can derive the PCP value based on local configuration (for example, the second device 120-1 may use the SR Class to Priority Mapping Table configuration) and combine the PCP with the received DMAC and VID.

At step 231, based on the updated information associated with the TSC stream, the first device 110 transmits the first header identification and third header information to the second device 120-1 which operates as the source interface end station for the TSC stream in the TSN network 101, and the third header information at least indicate the second header information. In some embodiments, the third header information indicates at least one of: the first DMAC, the first SMAC, the first VID, the first PCP, and the first mac_service_data_unit. The second device 120-1 stores the association between the first header identification and third header information.

In addition or alternatively, the third header information may further indicate a second identification associated to a certain port of a certain second device 120-1, when the second device 120-1 has multiple TSN available ports.

In some embodiments, at step 231, the first device 110 transmits the first header identification and third header information in N4 Session Modification Request. In turn, at step 233, the second device 120-1 may feedback N4 Session Modification Response.

At step 235, for accepting to process a data frame/packet belonging to the TSN stream, the first device 110 may also transmit a fourth header information to the second device 120-2 operating as the sink interface end station. The fourth header information may indicate at least a part of the second header information. In some embodiments, the fourth header information may indicate at least one of: the first DMAC, the first SMAC, the first VID, the first PCP, and the first mac_service_data_unit. In addition or alternatively, the fourth header information may further indicate a second identification associated to a certain port of a certain second device 120-2, when the second device 120-2 has multiple TSN available ports. In some embodiments, the first device 110 transmits the fourth header information to the second device 120-2 via the AMF. Correspondingly, in response to receiving the fourth header information, at step 236, the second device 120-2 transmits a responsive signaling (for example, ACK and/or NACK signaling) to the first device 110 via the AMF. The second device 120-2 stores the fourth header information and the associated second identification if available.

In addition or alternatively, the first device 110 may not transmit the TSN stream information to the second device 120-2, when for example, the first DMAC is a Multicast Address and the VLAN is accepted by the second device 120-2.

At step 237, the second device 120-1 may receive a data frame containing a fifth header. Upon receiving the data frame, the second device 120-1 uses the first header identification received from the first device 110 to check the fifth header identifying whether the data frame belongs to the TSC stream associated with the first header identification. In some embodiments, the associated first header identification refers to the first header identification generated by the third device 130 based on the configuration information of the TSC stream. For discussion clarity, the steps 237 and 239 may be discussed with reference to FIG. 3.

FIG. 3 illustrates a TSN transport frame 300 having a TSN transport header 330, a TSN transport payload 310, and a TSN transport Cyclic Redundancy Check (CRC) 340 according to some example embodiments of the present disclosure.

In the TSN transport payload 310 of the TSN Transport frame 300, a packet header 320 (which may be also referred to as fifth header) before a payload part and an additional TSN transport header 330 (which may be also referred to as a TSN transport header when the TSN transport frame is a TSN transport stream frame or a sixth header) are shown.

Once receiving a packet that is a TSC stream frame at least comprising a TSC header, at step 239, the second device 120-1 operating as a source interface end station checks whether the fifth header 320 matches with the first header identification. In some embodiments, the fifth header 320 comprises the DMAC (for example, the second DMAC) of the TSC stream. If the DMAC in the fifth header 320 is the same as the second DMAC in any of the stored first header identifications, the fifth header is determined to be matched with this stored first header identification. In some embodiments, the fifth header may comprise other information elements. In this case, if the parameters indicated by any of the stored first header identifications matches with respective element in the fifth header, then the fifth header is determined to be matched with this first header identification.

Once the fifth header and the first header identification being determined to be matched, the device 120-1 operating as the source interface end station may add the sixth header to the received data frame, such that the data frame can be uniquely identified by N3 interface in the Layer 2 as belonging to a certain TSN stream in the TSN transport network 101. In this example, the sixth header comprises the TSN transport stream header as TSN transport header 330. In some embodiments, the sixth header may comprise a Ethernet header when the source and sink interface endstations is based on a TSN transport network.

In some embodiments, based on the third header information received from the first device 110, the second device 120-1 concatenates the TSN transport stream header 330 in front of the TSN transport payload 310 that contains the received TSC stream frame. The TSN transport stream header 330 comprises at least one of: the first DMAC, first SMAC, first VID, and first PCP which may be indicated in the third header information. In some further embodiments, the TSN transport stream header 330 further comprises the second identification of the certain second device 120-1 or second identification of the certain port of the certain second device 120-1 into the sixth header. In this disclosure, this second identification added into the sixth header may be also referred to as a first SMAC.

In addition, as mentioned above, the SMF/CUC 110 or even the second device 120-1 may employ the local configuration, for example, the existing RAN node and UPF configuration, if the current VLAN or PCP parameter fits the TSN transport stream. In this case, the second header information may not comprise the PCP parameter or the VID, and this may implicitly indicate that employing the local configuration. Finally, the second device 120-1 may build the TSN transport stream header 330 based on at least one of the stored information related to the first header identification and the local configuration. Further, the second device 120-1 will add the GTP-U header of the PDU session used to exchange packets between UPF to UE.

In addition or alternatively, if the fifth header is determined to be not matched, the second device 110 derives another Ethernet header based on the existing RAN node and UPF configuration. The original Ethernet header will not be used for a TSN stream in the TSN Transport Network 101.

Returning back to FIG. 2, at step 241, if the fifth header is determined to be matched with the first header identification, the second device 120-1 uses the third header information to derive the sixth header used to transmit the TSN transport frame to the second device 120-2.

At step 243, once received a TSN transport frame (for example, Ethernet frame), the second device 120-2 checks whether the Ethernet header of the TSN transport frame addresses the second device 120-2. For example, if the second device 120-2 checks if the Ethernet header matches with at least one of the fourth header information and the local configuration. For another example, if the DMAC, VID of the TSN transport frame matches with the first DMAC, first VID indicated in the fourth header information, then the Ethernet header (or the sixth header) may be determined to match.

At step 245, upon detection that the sixth header addresses the second device 120-2, the second device 120-2 removes the sixth header added by the source interface end station 120-1 and processes the frame. For example, the second device 120.2 removes the GTP-U header information. Further, the second device 120-2 transmits the processed TSN Transport Frame to UE 190.

In addition or alternatively, the Network Entity M 160 or Network Entity N 150 may decide to terminate the TSC stream. Then the outer CNC 140 or the AF (not shown in the figures) may initiate the termination of the TSC stream. When the TSN AF 130 or TSCTSF not shown in the figures) receives the TSC stream configuration information to terminate a TSC stream, the following operation may be performed. The third device 130 may generate a first header identification which is associated with the TSC stream that needs to be terminated and provides the first header identification as termination request to the first device 110.

At the first device 110, when the information on terminating a TSC stream is received, the first device 110 uses the received first header identification to derive from stored data the respective StreamID of the TSN Transport stream and builds the TSN Transport Stream Requirements to terminate the TSN Transport Stream addressed by the StreamID.

Then, the stream requirements may initiate that the CNC 170 terminates the TSN Transport stream addressed by StreamID in the TSN Transport Network. Accordingly, the CNC 170 may response to the first device 110 with the communication configuration information containing the successful termination of the TSN Transport stream addressed by StreamID.

Moreover, the first device 110 informs the second devices 120-1 and 120-2 to remove the stored data that is assigned to the first header identification. Further, the first device 110 deletes its stored information associated to the stream ID and the first header identification.

It is to be understood that the disclosure can also be used in case that at least one of the N3 interface end points doesn't support VLANs or the stream transformation. As defined in IEEE Std 802.1Qcc-2018, the VLAN or stream transformation processing can then be performed by the edge bridge in the TSN transport network that connects the N3 interface end point. The respective VLAN or stream transformation information exchange between the first device 110 and the second device 120-1 and/or 120-2 can be omitted.

It is also to be understood that the above order of the steps is illustrated for presenting this disclosure without any limitation on the time sequence of the related steps.

FIG. 4 illustrates a flowchart 400 of an example method for the configuration of TSN implemented at a network device according to example embodiments of the present disclosure. The method 400 can be implemented at the first device 110 shown in FIG. 1. For the purpose of discussion, the method 400 will be described with reference to FIG. 1. It is to be understood that method 400 may further include additional blocks not shown and/or omit some shown blocks, and the scope of the present disclosure is not limited in this regard.

As shown in FIG. 4, at 410, in response to receiving a first header identification associated with a Time Sensitive Communication (TSC) stream, the first device 110 transmits to a configuration entity 170 of a transport network, a first stream requirement comprising two or more second identifications. Each of the two or more second identifications are associated with a corresponding second device 120 configured for an interface end station in a first protocol plane.

At 420, the first device 110 receives from the configuration entity, communication configuration information indicating second header information.

At 430, the first device 110 transmits to a second device 120-1 operating as a source interface end station, the first header identification and third header information at least indicating the second header information. The second device is associated with a second identification of the two or more second identifications.

In some embodiments, the first device 110 transmits to another second device 120-2 operating as a sink interface end station, TSN stream information indicating the fourth header information, the fourth header information indicating at least a part of the second header information, the other second device being associated with another second identification of the two or more second identifications.

In some embodiments, the first device 110 receives at least one corresponding second identification from each of a plurality of second devices configured for the interface end station, and wherein the plurality of second devices supports for Time Sensitive Networking (TSN).

In some embodiments, the first device 110 derives, from the plurality of second devices, the source interface end station and a sink interface end station in the transport network for the TSC stream, and wherein each of the two or more second identifications are associated with at least one of the source interface end station and the sink interface end station.

In some embodiments, the first stream requirement further comprises a unique stream identifier (ID) for the TSC stream, and wherein the unique stream ID is generated by the first device based on at least the second identification associated with the source interface end station.

In some embodiments, the at least one second identification comprises at least one of: a device identification of the second device; one or more port identifications of the second device.

In some embodiments, receiving the second identification comprises: receiving the second identification by at least one of an N4 session establishment response and an N4 session modification response; and/or receiving the second identification by at least one of an N2 PDU Session Response and an Nsmf_PDUSession_UpdateSM Context Request.

In some embodiments, receiving the first header identification comprises: receiving the first header identification from a third device configured for at least one of a TSN Application Function (TSN AF) and a Time Sensitive Communication Time Synchronization Function (TSCTSF).

In some embodiments, the second header information indicate at least one of: a first DMAC in the transport network; a first DMAC in the transport network; a first Virtual Local Area Network ID (VID) in the transport network; a first Priority Code Point (PCP) value in the transport network; and a first mac_service_data_unit in the transport network.

In some embodiments, the first header identification uniquely identifies the TSC stream, and wherein the first header identification is derived based on at least one of: a second DMAC of the TSC stream; a second VID of the TSC stream; a second Priority Code Pint (PCP); a second EtherType value; a second mac_service_data_unit; a second Source SMAC of the TSC stream; an Internet Protocol (IP) version 4 tuple of the TSC stream; and an IP version 6 tuple of the TSC stream.

In some embodiments, the first device is configured for at least one of a Session Management Function (SMF) and a Centralized User Configuration (CUC), and wherein the second device is configured for at least one of a Radio Access Network (RAN) node and a User Plane Function (UPF), and wherein the configuration entity comprises a Centralized Network Configuration (CNC).

In some embodiments, the first protocol plane comprises a User Plane, and wherein the interface end station comprises an N3 interface using a Layer 2 plane.

In some embodiments, the TSC stream comprises a stream transmitted over a Time sensitive network (TSN), and wherein the first device comprises a control node in a TSN transport network, and wherein the TSN transport network operates as part of a TSN bridge in the TSN network.

In some embodiments, the second header information indicates a second stream requirement of the TSC stream to be transmitted over the transport network.

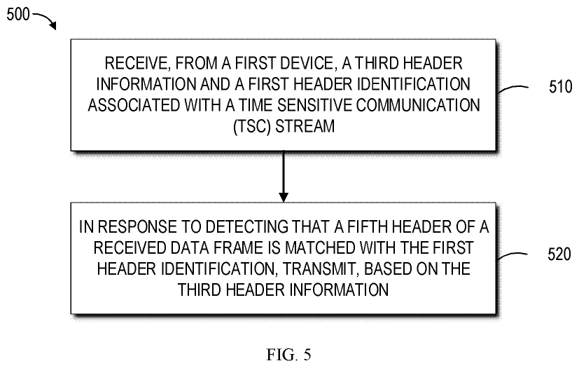

FIG. 5 illustrates a flowchart of an example method 500 for the configuration of TSN implemented at a network device according to example embodiments of the present disclosure. The method 500 can be implemented at the second device 120-1 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

At 510, the second device 120-1 receives, from a first device 110, a third header information and a first header identification associated with a Time Sensitive Communication (TSC) stream, wherein the second device is configured for an interface end station in a first protocol plane.

At 520, the second device 120-1 in response to detecting that a fifth header of a received data frame is matched with the first header identification, transmits, based on the third header information, the received data frame having a sixth header. The sixth header comprises the third header information.

In some embodiments, the second device supports for a Time Sensitive Networking (TSN).

In some embodiments, the second device 120-1 transmits at least one second identification associated with the second device to the first device.

In some embodiments, the at least one second identification comprises at least one of: a device identification of the second device; and one or more port identifications of the second device.

In some embodiments, the third header information further indicates at least one of: a first DMAC in the transport network; a first SMAC in the transport network; a first Virtual Local Area Network ID (VID) in the transport network; a first Priority Code Point (PCP) value in the transport network and a first mac_service_data_unit in the transport network.

In some embodiments, the first header identification uniquely identifies the TSC stream, and wherein the first header identification is derived based on at least one of: a second DMAC of the TSC stream; a second VID of the TSC stream; a second Priority Code Pint (PCP); a second EtherType value; a second mac_service_data_unit; a second SMAC of the TSC stream; an Internet Protocol (IP) version 4 tuple of the TSC stream; and a IP version 6 tuple of the TSC stream.

In some embodiments, the sixth header further comprises at least one of: the first DMAC; the first SMAC; the first VID; the first PCP; and the second identification associated with the second device.

In some embodiments, the first device is configured for at least one of a Session Management Function and a Centralized User Configuration (CUC) and wherein the second device is configured for at least one of a Radio Access Network (RAN) node and a User Plane Function (UPF).

In some embodiments, the first protocol plane comprises at least one of a User Plane, and wherein the interface comprises an N3 interface using Layer 2.

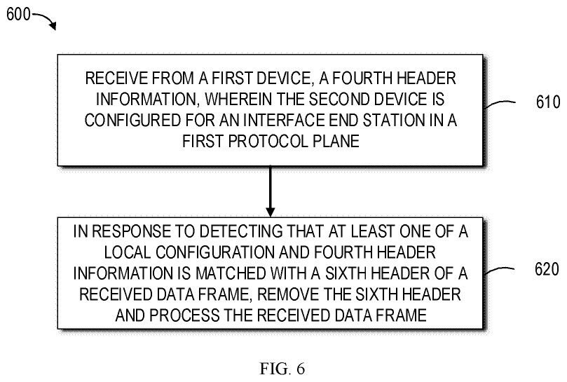

FIG. 6 illustrates a flowchart of an example method 600 for the configuration of TSN implemented at a network device according to example embodiments of the present disclosure. The method 600 can be implemented at the second device 120-2 shown in FIG. 1. For the purpose of discussion, the method 600 will be described with reference to FIG. 1. It is to be understood that method 600 may further include additional blocks not shown and/or omit some shown blocks, and the scope of the present disclosure is not limited in this regard.

At block 610, the second device 120-2 receives from a first device 110, a fourth header information, wherein the second device is configured for an interface end station in a first protocol plane.

At block 620, the second device 120-2 in response to detecting that at least one of local configuration and fourth header information is matched with a sixth header of a received data frame, remove the sixth header and process the frame.

In some embodiments, the second device supports for a Time Sensitive Networking (TSN).

In some embodiments, the second device 120-2 transmits at least one second identification associated with the second device to the first device.

In some embodiments, the at least one second identification comprises at least one of: a device identification of the second device; one or more port identifications of the second device.

In some embodiments, the fourth header further indicates at least one of: a first DMAC in the transport network; a first SMAC in the transport network; first VID in the transport network; a first PCP value in the transport network; and the second identification associated to the second device; and a first mac_service_data_unit in the transport network.

In some embodiments, the first device is configured for at least one of a Session Management Function and a Centralized User Configuration (CUC) and wherein the second device is configured for at least one of a Radio Access Network (RAN) node and a User Plane Function (UPF).

In some embodiments, the first protocol plane comprises at least one of a User Plane, and wherein the interface comprises an N3 interface using a Layer 2 plane.

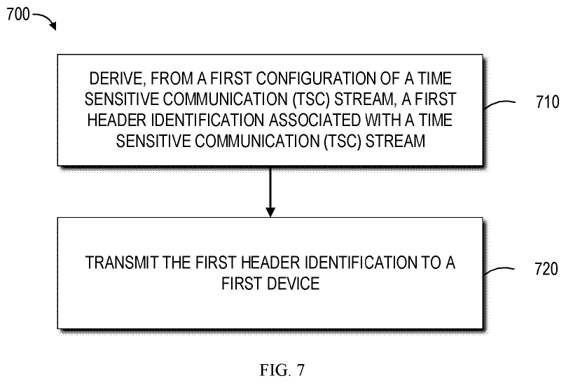

FIG. 7 illustrates a flowchart of an example method 700 for the configuration of TSN implemented at a network device according to example embodiments of the present disclosure. The method 700 can be implemented at the third device 130 shown in FIG. 1. For the purpose of discussion, the method 700 will be described with reference to FIG. 1. It is to be understood that method 700 may further include additional blocks not shown and/or omit some shown blocks, and the scope of the present disclosure is not limited in this regard.

At 710, the third device 130 derives, from a first configuration of a Time Sensitive Communication (TSC) stream, a first header identification associated with a Time Sensitive Communication (TSC) stream.

At 720, the third device 130 transmits the first header identification to a first device.

In some embodiments, the first header identification uniquely identifies the TSC stream, and wherein the first header identification is derived based on at least one of: a second DMAC of the TSC stream; a second VID of the TSC stream; a second Priority Code Pint (PCP); a second EtherType value; a second mac_service_data_unit; a second SMAC of the TSC stream; an Internet Protocol (IP) version 4 tuple of the TSC stream; and an IP version 6 tuple of the TSC stream.

In some embodiments, the first configuration is received from at least one of a Centralized Network Configuration (CNC) and an Application Function (AF) outside a transport network associated with the third device.

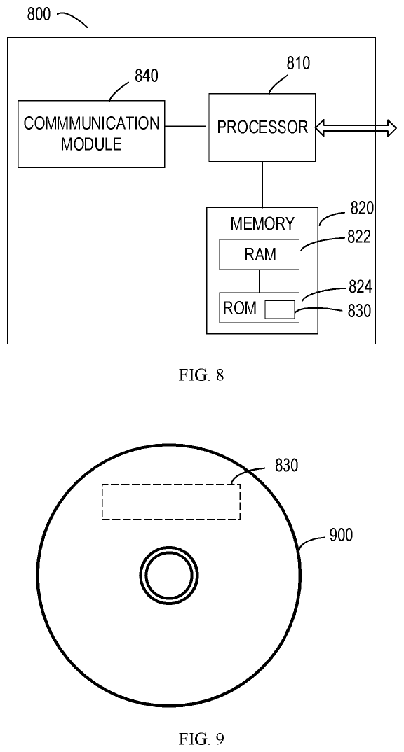

FIG. 8 is a simplified block diagram of a device 800 that is suitable for implementing embodiments of the present disclosure. The device 800 may be provided to implement the communication device, for example the first device 110, the second devices 120-1 and 120-2 and the third device 130 as shown in FIG. 1. As shown, the device 800 includes one or more processors 810, one or more memories 820 coupled to the processor 810, and one or more transmitters and/or receivers (TX/RX) 840 coupled to the processor 810.

The TX/RX 840 may be configured for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage media. Examples of the volatile memories include, but are not limited to, a Random Access Memory (RAM) 822 and other volatile memories that will not last in the power-down duration.

A computer program 830 includes computer executable instructions that may be executed by the associated processor 810. The program 830 may be stored in the ROM 824. The processor 810 may perform any suitable actions and processing by loading the program 830 into the RAM 822.

The embodiments of the present disclosure may be implemented by means of the program 830 so that the device 800 may perform any process of the disclosure as discussed with reference to FIG. 2. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9. shows an example of the computer readable medium 900 in form of CD or DVD. The computer readable medium has the program 830 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out any of the method 400 to 700 as described above with reference to FIGS. 4-7. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-42. (canceled)

43. A first device, comprising:
at least one processor; and
at least one memory including computer program codes;
the at least one memory and the computer program codes are configured to, with the at least one processor, cause the first device at least to:
in response to receiving a first header identification associated with a Time Sensitive Communication (TSC) stream, transmit, to a configuration entity of a transport network, a first stream requirement comprising two or more second identifications, wherein each of the two or more second identifications is associated with a corresponding second device configured for an interface end station in a first protocol plane;
receive, from the configuration entity, communication configuration information indicating second header information; and
transmit, to a second device operating as a source interface end station, the first header identification and third header information at least indicating the second header information, the second device being associated with a second identification of the two or more second identifications.

44. The first device of claim 43, wherein the at least one memory and the computer program codes are configured to, with the at least one processor, further cause the first device to:
transmit, to another second device operating as a sink interface end station, TSN stream information indicating the fourth header information, the fourth header information indicating at least a part of the second header information, the other second device being associated with another second identification of the two or more second identifications.

45. The first device of claim 43, wherein the at least one memory and the computer program codes are configured to, with the at least one processor, further cause the first device to:
receive at least one corresponding second identification from each of a plurality of second devices configured for the interface end station, and wherein the plurality of second devices support for Time Sensitive Networking (TSN).

46. The first device of claim 45, wherein the at least one memory and the computer program codes are configured to, with the at least one processor, further cause the first device to:
derive, from the plurality of second devices, the source interface end station and a sink interface end station in the transport network for the TSC stream, and wherein each of the two or more second identifications is associated with at least one of the source interface end station and the sink interface end station.

47. The first device of claim 46, wherein the first stream requirement further comprises a unique stream identifier (ID) for the TSC stream, and wherein the unique stream ID is generated by the first device based on at least the second identification associated with the source interface end station.

48. The first device of claim 45, wherein the at least one second identification comprises at least one of:
a device identification of the second device; and
one or more port identifications of the second device.

49. A second device, comprising:
at least one processor; and
at least one memory including computer program codes;
the at least one memory and the computer program codes are configured to, with the at least one processor, cause the second device at least to:
receive, from a first device, a third header information and a first header identification associated with a Time Sensitive Communication (TSC) stream, wherein the second device is configured for an interface end station in a first protocol plane; and
in response to detecting that a fifth header of a received data frame is matched with the first header identification, transmit, based on the third header information, the received data frame having a sixth header, the sixth header comprising the third header information.

50. The second device of claim 49, wherein the second device supports for a Time Sensitive Networking (TSN).

51. The second device of claim 49, wherein the at least one memory and the computer program codes are configured to, with the at least one processor, further cause the second device to:
transmit at least one second identification associated with the second device to the first device.

52. The second device of claim 51, wherein the at least one second identification comprises at least one of:
a device identification of the second device; and
one or more port identifications of the second device.

53. The second device of claim 49, wherein the third header information further indicates at least one of:
a first Destination MAC Address (DMAC) in the transport network;
a first Source MAC Address (SMAC) in the transport network;
a first Virtual Local Area Network ID (VID) in the transport network;
a first Priority Code Point (PCP) value in the transport network; and
a the first mac_service_data_unit in the transport network.

54. The second device of claim 49, wherein the first header identification uniquely identifies the TSC stream, and wherein the first header identification is derived based on at least one of:
a second DMAC of the TSC stream;
a second VID of the TSC stream;
a second PCP;
a second EtherType value
a second mac_service_data_unit
a second SMAC of the TSC stream;
a Internet Protocol (IP) version 4 tuple of the TSC stream; and
a Internet IP version 6 tuple of the TSC stream.

55. The second device of claim 49, wherein the sixth header further comprises at least one of:
the first DMAC;
the first SMAC
the first VID; and
the first PCP.

56. A second device, comprising:
at least one processor; and
at least one memory including computer program codes;
the at least one memory and the computer program codes are configured to, with the at least one processor, cause the second device at least to:
receive from a first device, a fourth header information, wherein the second device is configured for an interface end station in a first protocol plane; and
in response to detecting that at least one of a local configuration and fourth header information is matched with a sixth header of a received data frame, remove the sixth header and process the frame.

57. The second device of claim 56, wherein the second device supports for a Time Sensitive Networking (TSN).

58. The second device of claim 56, wherein the at least one memory and the computer program codes are configured to, with the at least one processor, further cause the second device to:
transmit at least one second identification associated with the second device to the first device.

59. The second device of claim 56, wherein the at least one second identification comprises at least one of:
a device identification of the second device; and
one or more port identifications of the second device.

60. The second device of claim 56, wherein the fourth header information further indicates at least one of:
a first Destination MAC Address (DMAC) in the transport network;
a first Source MAC Address (SMAC) in the transport network;
a first Virtual Local Area Network ID (VID) in the transport network;
a first Priority Code Point (PCP) value in the transport network; and
a first mac_service_data_unit in the transport network.

61. The second device of claim 56, wherein the first device is configured for at least one of a Session Management Function and a Centralized User Configuration (CUC) and wherein the second device is configured for at least one of a Radio Access Network (RAN) node and a User Plane Function (UPF).

62. The second device of claim 56, wherein the first protocol plane comprises at least one of a User Plane, and wherein the interface comprises an N3 interface using a Layer 2 plane.
